(19) United States
(12) Patent Application Publication
(10) Pub. No.: US 2005/0220173 A1
(43) Pub. Date: Oct. 6, 2005

(54) Methods and systems for frequency shift keyed modulation for broadband ultra wideband communication

(75) Inventors: James G. Zyren, Melbourne Beach, FL (US); Michael J. Seals, Melbourne, FL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Conexant Systems, Inc., Red Bank, NJ (US)

(21) Appl. No.: 11/078,721

(22) Filed: Mar. 14, 2005

Related U.S. Application Data
(60) Provisional application No. 60/552,445, filed on Mar. 12, 2004.
(60) Provisional application No. 60/564,978, filed on Apr. 26, 2004.

(51) Int. Cl. H04B 1/69

(52) U.S. Cl. 375/130

(57) ABSTRACT

A system and method for transmitting a UWB or WB signal over a wireless network using a CP-FSK modulated carrier waveform. The system and method comprises selecting a wireless communication channel that is free of at least one of interference and multipath distortion and transmitting a CP-FSK modulated signal over the selected channel having a modulation index of ≦0.707, a bandwidth of at least 500 MHz, a power spectral density of ≦−41.3 dBm/MHz, and a frequency range of 3.1 GHz to 10.6 GHz.

### FIELD OF THE INVENTION

The present invention relates generally to using frequency modulation techniques in single channel communications system to simplify transmission and reception and to optimize power spectral density (PSD) and more particularly to using a continuous phase frequency shift keyed (CP-FSK) modulation for wideband (WB) and ultra wideband (UWB) communication channel applications. The present invention also describes the means by which the transmitted signal can be adapted to optimize signal reliability and to minimize impact on incumbent users within the allowed WB and UWB spectrum.

### BACKGROUND OF THE INVENTION

UWB communication technology develops, transmits and receives extremely short duration bursts of radio frequency (RF) energy. Typically, the burst lasts from a few tens of picoseconds (trillionths of a second) to a few nanoseconds (billionths of a second) in duration. Each burst represents one to a few cycles of an RF carrier wave.

As a result, the reconstructed waveforms are extremely broadband. Due to the short time duration of UWB waveforms, they have unique and useful properties applicable to communications. For example, UWB pulses can be used to provide extremely high data rate performance in multi-user network applications. Also, in radar applications, these pulses can provide very fine range resolution and/or positioning measurement capabilities. Though UWB connection speeds decrease quickly as a function of distance, they have the potential to transmit data up to a 1000 times faster than 802.11b.

In February of 2002, the FCC opened up the frequency spectrum from 3.1 GHz to 10.6 GHz for use by UWB devices which are defined to have a minimum −10 dB bandwidth of 500 MHz or have a fractional bandwidth of at least 0.20. However, because this frequency spectrum is also allocated to other devices, such as commercial mobile radio service (CMRS) providers, the power spectral density (PSD) was limited to −41.3 dBm/MHz to avoid interference with other devices operating in the same spectrum. Though proponents of UWB promise ranges on the order of 10 meters, the −41.3 dBm/MHz maximum for PSD will effectively limit full use of the spectrum for high data rate applications to distances on the order of 2-3 meters. At these ranges, multi-path interference is often not as significant of a consideration. Because of the short distance of operation, UWB devices will likely be limited to cable replacement for high bandwidth devices such as modems, digital video devices and other electronic devices typically connected by cords.

To date, several proposals have been made for waveforms suitable for UWB communications. The IEEE 802.15.3a Task Group is considering two such waveforms: multi-band orthogonal frequency division multiplexing (MB-OFDM) and direct sequence spread spectrum (DSSS). MB-OFDM uses orthogonal frequency division multiplexing techniques to transmit the information on each of the sub-bands. OFDM has several desirable properties, including high spectral efficiency, inherent resilience to RF interference and the ability to efficiently compensate for multi-path distortion. OFDM is also well understood and has been proven in other commercial technologies such as IEEE 802.11a/g. In the presence of multi-path distortion, channel equalization is done in the frequency domain via a fast fourier transform (FFT). However, successful implementation of an OFDM system requires a highly linear receiver front end and an FFT engine in the baseband processor. These requirements will drive the cost and power consumption of an MB-OFDM UWB system to levels comparable to those of WLAN products. Also, given the current state of RF CMOS technology, multi-band OFDM is still limited to operating in only a portion of the spectrum, form 3.1 GHz to 4.8 GHz. Building RF and analog circuits as well as high speed analog-to-digital converters to process this extremely wideband signal is a challenging problem.

In direct sequence spread spectrum systems (DSSS), also known as direct sequence code division multiple access (DSCDMA), all users transmit in the same bandwidth simultaneously. Because the data signal is spread using a code that is unique to each user or channel in the system, interference with other users is avoided. In direct sequence spread spectrum systems the data signal is multiplied by a pseudo random noise code (PNcode). One such PNcode is a sequence of chips valued at either −1 and 1 or 0 and 1 and has noise-like properties resulting in low cross-correlation values among codes. Advantages to spread spectrum systems include low power spectral density, use of the entire frequency spectrum, privacy due to random codes and reduction of multi-path effects. In the case of DSSS, a conventional time-domain channel equalizer is used to correct signal impairments induced by multi-path. At higher data rates or higher root mean square (RMS) delay spreads, equalizer complexity increases dramatically increasing systems cost, complexity and power consumption. Like multi-band OFDM, the benefits of DSSS are less important for short range solutions and are outweighed by design and implementation costs.

Another design problem of UWB systems is that of interference to other users in the available spectrum. For example, different UWB enabled devices may operate in overlapping portions of the spectrum creating interference on particular channels. Moreover, because some of the spectrum allocated for UWB devices is already used by mobile communication service providers, interference may exist with devices operating within sufficient proximity to UWB enabled devices.

Thus, there exists a need for a waveform for use with UWB devices which stays within the FCC required PSD limits, mitigates the problem of multi-path interference and minimizes interference with other users of the spectrum, and offers reduced cost and power consumption. Original FCC regulations for UWB devices required a minimum channel width of 500 MHz. This requirement increased the potential for interference with other users of the spectrum and complicated equipment design. The FCC recognized these issues and in December of 2004 it released a Second Report and Order allowing wideband systems (WB), those with a −10 dB bandwidth of at least 50 MHz, to operate in the 5.925 GHz to 7.250 GHz band with the same maximum PSD limit of −41.3 dBm/MHz as enjoyed by UWB systems. WB systems operating in this band have a different PSD limit outside the 5.925 GHz to 7.250 GHz band than do UWB systems. The intent of the new WB signals is to provide a new class of systems that do not needlessly waste spectrum in order to be classified as a UWB radio reducing interference to existing receivers. Simultaneously, the narrower WB receivers have eased design requirements when dealing with interference since the channel bandwidth may be narrower that UWB receivers.

### SUMMARY OF THE INVENTION

The present invention mitigates or solves the above-identified limitations of proposed WB and UWB waveforms, as well as other unspecified deficiencies in these proposed solutions. A number of advantages associated with the present invention are readily evident to those skilled in the art, including economy of design and resources, reduction of power consumption, cost savings, etc.

Disclosed herein are various exemplary systems and methods for improved and effective data transmission in WB and UWB communications systems. As noted above, due to restrictions on power density imposed by the FCC, WB and UWB will be effectively limited to short range (2-3 meters) applications such as cable replacement, thereby making multi-path distortion only a secondary consideration. At short range, root mean square (RMS) delay spreads will be on the order of 5-10 nsec, rather than the 20-25 as currently specified by IEEE 802.15.3a channel models. Thus, a simple non-linear modulation technique such as CP-FSK will be more than adequate for general use in devices with existing USB 2.0 and IEEE 1394 (firewire) wired interfaces. Thus, the various exemplary systems and methods disclosed herein are relatively simple and less expensive than current methods being considered by the 802.15.3a Task Group for UWB communication. The DSSS and MB-OFDM approaches are both driven by a multi-path requirement that assumes distances up to 10 meters. But, in practice, allowable UWB power levels are simply too low to achieve these distances. Also, significant applications exist in the realistic range of 2-3 meters. At these ranges, FSK is a much more economical and practical solution than either DSSS or MB-OFDM.

The various exemplary systems and methods disclosed herein will provide equivalent WB or UWB performance to DSSS and MB-OFDM waveforms at significantly reduced cost and simplified implementation. An FSK communications link operating under WB or UWB rules may utilize a very wide bandwidth, on the order of 50 to 1000 MHz. With a modulation index of approximately 0.7 to 0.8, this would permit instantaneous data rates of several hundred MBPS. Also, the flat PSD of this waveform would permit transmission of the maximum power density across the spectrum under the FCC rules. In addition, using a fairly large modulation index will also result in efficient signaling that should come within 1 to 2 dB of a comparable system using orthogonal signaling (modulation index of 1.0). Finally, a modulation index of 0.707 is the point at which digital FM communication links begin to exhibit a capture effect, helping to suppress both interference and the effects due to multi-path distortion.

FSK digital modulation has several desirable properties for WB and UWB applications. Firstly, simple implementations already exist for both transmitters and receivers. Secondly, continuous phase FSK (CP-FSK) is a constant envelope waveform, thus instantaneous amplitude of the waveform does not change with time. Therefore, linearity requirements on the receiver are very benign; a simple limiter-discriminator receiver architecture is quite suitable. Constant envelope modulation allows a transmitter's power amplifier to operate at or near saturation levels, whereas standard BPSK, QPSK and QAM modulations contain AM components in the modulated envelope, which requires a back off from saturation in output power to reduce or eliminate spectrum splatter of sideband components that might cause adjacent channel interference (ACI). Also, most non-constant envelope modulations require full linear power amplification and therefore, for similar power output, require amplifiers that are less efficient, consume more power, generate more heat and are more costly. Given the low power levels of WB and UWB devices, impact of non-constant envelope waveforms is a secondary consideration. Finally, using a modulation index of 0.7-0.8 will promote efficient signaling and generate a flat PSD with good spectral side-lobe properties while remaining within the FCC PSD limit of −41.3 dBm/MHz. A modulation index of ≧0.707 will result in a non-coherent limiter-discriminator based receiver that is capable of exploiting a “capture effect.” A capture effect is the ability to suppress weaker interfering signals and can help combat any multi-path distortion.

Another feature of the invention is passively scanning the RF channel to detect other users. In various exemplary embodiments of the invention, if other users are detected operating on a given channel, the system can tune to another channel or reduce the signal bandwidth to avoid encroaching on occupied spectrum, including switching from UWB bandwidths to WB bandwidths. The presence of other users can be simply detected by monitoring the channel for any RF energy signals that are above a threshold power level. If a signal of sufficient power is detected on the current channel, the receiver can be tuned to a different channel until a channel free of signal interference is found. Conversely, if there are no users detected in a given band the system bandwidth may be increased.

Once a clean channel within the spectrum is identified, the integrity of the transmitted signal can be determined by means of sending a known digital training sequence between the originating and receiving device. If the received signal strength is adequate and no interference is present, it is still possible for the signal to undergo severe distortion due to multi-path. The degree of multi-path distortion that the signal undergoes, while caused by the physical topology of the signal path, is highly dependent on center frequency and bandwidth. Therefore, if severe multi-path distortion is detected on a given channel, the same techniques described above to minimize interference with other users (variable channel width and frequency agility) can be used to locate spectrum that is free of both severe multi-path distortion and interference from other users.

Passive scanning for interference can be accomplished simply by monitoring a channel for the presence of RF energy. If energy above an arbitrary threshold is detected, the channel would be considered occupied. Channel frequency and/or bandwidth can then be adjusted to avoid the source of the interference. The channel can then be re-scanned to determine the effectiveness of the measures taken. This process would be repeated until suitable spectrum is identified.

The same process would be followed to identify spectrum that is free of severe multi-path distortion. However, this does require transmission of a known training sequence from the transmitter to the receiver. If the signal strength is adequate for successful demodulation, but the signal cannot be successfully demodulated (and the channel has previously determined to be free of interference), it can be assumed that the local environment is causing severe multi-path distortion for the given channel. Channel frequency and/or bandwidth can then be adjusted in order to locate spectrum that does not suffer from severe multi-path distortion. The channel can then be re-scanned to determine the effectiveness of the measures taken. This process would be repeated until suitable spectrum is identified.

Another method that can be employed to reduce the effect of multipath distortion on an FSK system is to increase the symbol duration. This can be accomplished by decreasing the data rate and thereby increasing symbol duration and decreasing channel width. Even if significant multipath distortion is present on the narrower channel, a longer symbol duration can suppress the effects of signal distortion. A second technique would be to increase the modulation complexity (e.g., shift from 2-FSK to 4-FSK) to reduce the symbol rate while holding the data rate constant. A combination of these methods might also be employed.

Another problem faced by designers of WB and UWB systems is limited operating range. FCC regulations specify a peak operating power that is 20 dB above the average power limit of −41.3 dBm/MHz. WB and UWB systems operating under these rules could employ a variety of methods to increase instantaneous peak transmitted RF power while reducing transmitter duty cycle accordingly to comply with FCC limits for average transmitted power. For example, a WB or UWB device could increase peak transmit power by 10 dB if transmitter duty cycle were reduced to 10% (when averaged over a suitable duration). One method of implementing this technique would be to create a Medium Access Controller (MAC) level Virtual Carrier Sense mechanism that would automatically indicate a busy medium for a suitable period of time after each transmission, thereby preventing subsequent data transmissions until a suitable period of time had elapsed.

In accordance with one exemplary embodiment of the present invention, a method for transmitting data over a WB or UWB network is provided. The method comprises scanning for a WB and/or a UWB channel free of interference from other devices operating in the spectrum, finding a channel which is free of interference above a threshold level and/or multi-path distortion, and transmitting a CP-FSK modulated information signal using a CP-FSK communications link operating under FCC WB and UWB frequency and PSD limits.

In accordance with another exemplary embodiment of the present invention, a method for receiving data over a WB or UWB network is provided. The method comprises the steps of receiving and demodulating a CP-FSK modulated WB or UWB signal with a demodulating circuit to decode the information signal.

In accordance with an additional exemplary embodiment of the present invention, a transmitter is provided. The transmitter comprises a CP-FSK modulator, amplifier and control circuit causing the transmitter to output a signal having a frequency spectrum between 3.1 and 10.6 GHz with a bandwidth of at least 500 MHz and a power spectral density of ≦−41.3 dBm/MHz.

In accordance with an additional exemplary embodiment of the present invention, a transmitter is provided. The transmitter comprises a CP-FSK modulator, amplifier and control circuit causing the transmitter to output a signal having a frequency spectrum between 5.925 GHz and 7.250 GHz with a bandwidth of at least 50 MHz and a power spectral density of ≦−41.3 dBm/MHz.

In accordance with yet another embodiment of the present invention, a receiver is provided. The receiver comprises a demodulator capable of demodulating a CP-FSK modulated signal and recovering the original information signal.

In accordance with an additional embodiment of the present invention, a computer readable medium for processing data transmitted over a WB and/or a UWB network is provided. The computer readable medium comprises a plurality of executable instructions being adapted to manipulate a processor to transmit an information signal as a digital bitstream. The computer readable medium further comprises a plurality of executable instructions being adapted to manipulate a processor to perform a CP-FSK modulation on the digital bitstream to create a modulated communication signal. The computer readable medium also comprises a plurality of executable instructions being adapted to manipulate a processor to transmit the modulated communication signal in accordance with WB and/or UWB protocol.

In accordance with yet another embodiment of the present invention, a computer readable medium for processing data received over a WB and/or a UWB network is provided. The computer readable medium comprises a plurality of executable instructions being adapted to manipulate a processor to receive a CP-FSK modulated WB and/or UWB communication signal and to demodulate the signal and recover the data.

In various exemplary embodiments of the systems and methods according to this invention, a CP-FSK communication link is provided for transmitting a signal with improved PSD within FCC allowable limits. In various other exemplary embodiments of the systems and methods according to this invention, a CP-FSK communications link is provided that generates a WB or a UWB waveform with a relatively flat PSD, thereby maximizing the allowable transmission power. In various other exemplary embodiments of the systems and methods according to this invention, a CP-FSK communications link is provided that generates a WB or a UWB waveform with a modulation index of ≧0.707.

These and other features and advantages of the present invention are identified in the ensuing description, with reference to the drawings identified below.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is a schematic diagram of an exemplary wireless device used to transmit data over a WB or a UWB network to a receiving device in accordance with at least one embodiment of the present invention;

FIG. 2 is a block diagram illustrating an exemplary transmitter for the wireless device of FIG. 1 for transmitting a WB or a UWB communication signal in accordance with at least one embodiment of the present invention;

FIG. 3 is a block diagram illustrating an exemplary FSK modulator for use with the WB or UWB transmitter of FIG. 2 in accordance with at least one embodiment of the present invention;

FIG. 4 is a series of graphs illustrating FSK modulation of digital data in accordance with at least one embodiment of the present invention;

FIG. 5 is a series of graphs illustrating the resulting FSK waveform for a plurality of modulation indices in accordance with at least one embodiment of the present invention;

FIG. 6 is a flow chart illustrating the steps of a method of transmitting an FSK modulated WB or UWB signal with reduced interference and distortion in accordance with at least one embodiment of the present invention; and

FIG. 7 is a flow chart illustrating in greater detail the steps of a method for reducing interference and distortion on a WB or a UWB channel employing a FSK modulated waveform in accordance with at least one embodiment of the present invention.

### DETAILED DESCRIPTION OF THE INVENTION

The following description is intended to convey a thorough understanding of the present invention by providing a number of specific embodiments and details involving data transmission in a WB or a UWB communication channel. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

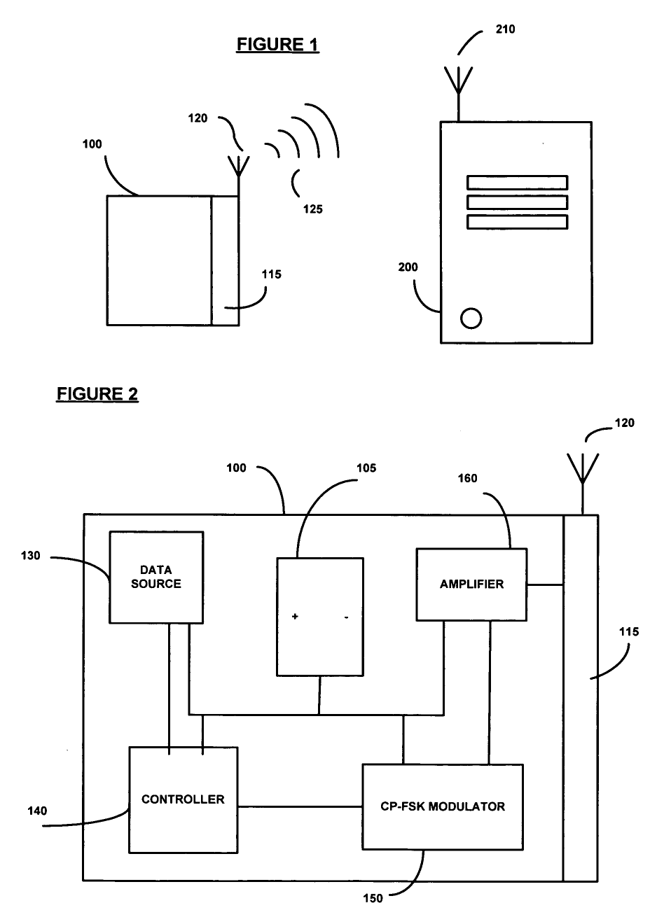

FIGS. 1-5 illustrate various exemplary mechanisms for processing and transmitting data in a WB or a UWB communication system. In at least one embodiment, a transmitter may be in communication with a receiver over a single wireless WB and/or UWB channel. For the purposes of this disclosure, the term UWB channel will be used to describe, by way of example, an FSK modulated RF signal operating in the range of 3.1 to 10.6 GHz, having a −10 dB bandwidth of 500 MHz or a fractional bandwidth of at least 0.20, and having a PSD of −41.3 dBm/MHz. Likewise the term WB channel will be used to describe, by wave of example, an FSK modulated RF signal operating within the range of 5.925 GHz to 7.250 GHz, having a −10 dB bandwith of at least 50 MHz, and having a PSD of −41.3 dBm/MHz.

For ease of discussion, the various exemplary systems and techniques of the present invention are described in the context of a wireless information device, such as, for example, desktop and notebook computers, PDAs, tablet computers, and cell phones, communicating with a computer over a wireless WB or UWB channel. Those skilled in the art, however, may adapt the exemplary systems and techniques to any short range communication system where there is a need to exchange large amounts of data quickly and to replace a corded communications channel. The present invention may be useful with audio and video component systems, home theater systems, wireless internet portals, video recording and playback devices, audio recording and playback devices, data storage devices or any other electronic device, that typically communicate over a single wired channel, without departing from the spirit or the scope of the present invention.

Referring now to FIG. 1, an exemplary data transmission system 100 having improved data transmission rates achieved at least in part through the combined use of CP-FSK modulation techniques is illustrated in accordance with at least one embodiment of the present invention. In the illustrated example of FIG. 1, the system includes a wireless device 100 having a wireless WB and/or UWB transmitter 110 that transmits a wireless CP-FSK modulated WB and/or UWB signal 125 with an antenna 120. The components of the transmitter 106 may be implemented as software, hardware, firmware, or a combination thereof. In various exemplary embodiments, the wireless WB or UWB signal 125 is transmitted with the antenna 120 so as to propagate evenly in all directions. In various other exemplary embodiments, it may be desirable for the wireless WB or UWB signal 125 to be focused in a single direction of propagation by the antenna 120.

The wireless WB or UWB signal 125 is received by an antenna 210 attached to or in communication with an electronic device, such as, for example, a computer system 200. The signal travels from the antenna 210 to a receiver (not illustrated) in the computer. The receiver may be a separate card containing a signal processor capable of demodulating the WB or UWB signal 125, a virtual receiver comprised of software instructions which cause the microprocessor of the computer to demodulate the signal 125 or mixtures thereof.

In the example of FIG. 1, the WB or UWB communication channel between the wireless device 100 and the computer system 200 is one-directional. However, it should be appreciated by those of ordinary skill in the art that it may be advantageous and/or desirable for the communication channel to be bidirectional. Such a bi-directional WB or UWB communications channel could be implemented by including receiving and transmitting means in the wireless device 100 and computer system 200 respectively.

The transmitter 110, in at least one embodiment, is adapted to transmit data over the wireless WB or UWB channel to the receiver in the computer 200 using a continuous phase frequency shift keyed (CP-FSK) modulation technique with a modulation index of approximately 0.7 to 0.8. For the purposes of this disclosure, the term modulation index will be taken to mean the ratio of the separation between the two FSK modulation tones and the symbol rate. For example, if the two tones of the FSK modulated signal are separated by 700 kHz and the symbol rate is 1 Mb, the modulation index will be approximately 0.7. As will be discussed later, FSK waveform performance will degrade with under and over deviation, or mod indices that are too low or too high.

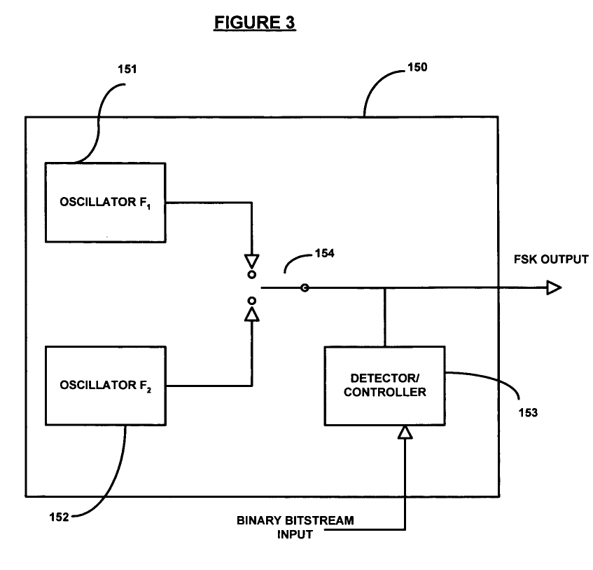

Referring now to FIG. 2, FIG. 2 illustrates a block diagram of exemplary WB and/or UWB enabled wireless device 100 of FIG. 1 including the individual components of the wireless WB and/or UWB system. As seen in FIG. 2, the device 100 contains a power supply circuit 105, a data source 130 of electronic data, a controller 140, a CP-FSK modulator 150, an amplifier 160 and the transmitter 110.

The power supply circuit 105 may include a power storage device or it may simply draw power from the power supply of the wireless device 100. The controller 140 may be implemented as a microprocessor or central processing unit (CPU), an application specific integrated circuit (ASIC), a digital signal processor (DSP) or the like.

Additionally, the data source 130 may comprise a buffer memory or may simply be a connection to the memory native to the wireless device 100. The data in the data source 130 is stored as digital bits and could be any type of digital information including audio, video, text data and mixtures thereof.

During wireless WB or UWB transmission of the data stored in the data source 130, the controller 140 causes the data source to send the data to the CP-FSK modulator 150 as a digital bitstream. The modulator 150 modulates the bit stream into a continuous two tone RF signal in accordance with the two oscillation frequencies of the modulator 150. The CP-FSK modulated signal is then sent to an amplifier 160 just before entering the transmitter 110. In various exemplary embodiments, the transmitter 110 and the amplifier 160 may be integrated into a single device without departing from the spirit or scope of this invention. As mentioned above, it is important for the CP-FSK modulator to use a modulation index between 0.5 and 1 and preferably at least 0.7. One reason for this is that at a modulation index of 0.7, the so-called “capture effect” begins to manifest. The capture effect in digital FM communication refers to the phenomena that for signals having a modulation index of ≧0.707, weaker signals due to interference and multi-path distortion are suppressed. Additional reasons for selecting a modulation index of approximately 0.7 to 0.8 will be discussed below in the context of FIG. 5.

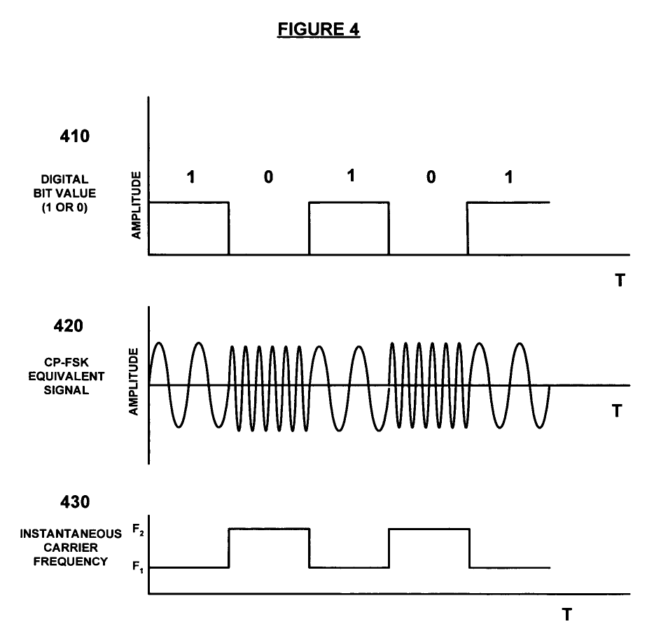

Referring now to FIG. 3, FIG. 3 illustrates an exemplary FSK modulator for use with this invention. It should be appreciated that FSK modulators are well known in the art and therefore the specific type and/or configuration of the FSK modulator is not critical to the invention. The modulation index of the modulator is of much greater significance than the actual design of the modulator. Thus, any presently commercially available or suitable yet to be developed FSK modulator may be substituted without departing from the spirit or scope of this invention.

FIG. 3 is representative of the function of an FSK modulator as well as of a basic component-wise design on an FSK modulator. In FIG. 3, an exemplary FSK modulator 150, such as that shown in FIG. 2, is illustrated in greater detail. In its simplest form, a binary bitstream representing an information signal to be encoded enters a detector/controller 153 of the modulator 150. A pair of oscillators 151 and 152 each generate a tone signal which is separated by a predetermined frequency separation. For example, the first oscillator 151 may oscillate at 3 MHz, while the second oscillator 152 oscillates at 3.8 MHz, giving a separation of 800 kHz. As each bit enters the detector/controller, the detector/controller 153 determines if the bit is a one or a zero. The detector/controller 153 then actuates a switch 154 in response to this determination. Each bit, one or zero, is assigned to one of the tones such that detection of a one will cause the switch 154 to conduct the signal from the first oscillator 151, while detection of a zero will cause the switch 154 to conduct the signal from the second oscillator 152. A continuous output of a composite signal which modulates between the frequency of the first oscillator 151 and the second oscillator 152 is output by the FSK oscillator. The decoder at the receiver will use the same association between bit and frequency so that the FSK modulated signal can be accurately decoded.

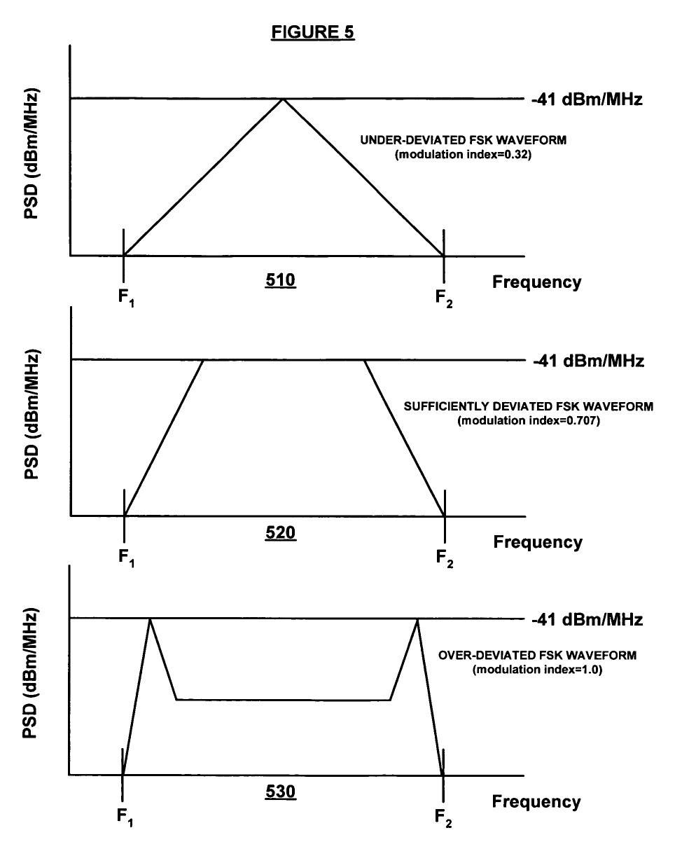

Referring now to FIG. 4 a series of graphs illustrating FSK modulation of a digital signal in accordance with at least one exemplary embodiment of this invention are shown. In FIG. 4, the digital bitstream 410 is a two level digital signal representing ones and zeros propagating in time. The FSK modulated equivalent signal 420 of the digital bitstream 410 changes frequency in response to changes in the level of the bitstream. In this two frequency example of the signal 420, a relatively low frequency signal is shown for periods in time corresponding to ones and a relatively high frequency signal corresponding to zeros.

Graph 430 illustrates the instantaneous carrier frequency as a function of time for the same period shown in graphs 410 and 420. As shown in graph 430, the frequency of the FSK modulated signal undergoes rapid changes at the bit changes. Graph 420 illustrates the benefits of continuous phase FSK. As seen in graph 420, when the frequency changes from high to low or vice versa, there are no breaks in phase. Breaks in phase due to modulation frequency change can interfere with demodulation. In the FSK modulators, a phase detector monitors phase so that changes in frequency are still synchronized in phase. Also, graph 420 illustrates that the FSK equivalent signal is a constant envelope signal. That is to say that amplitude remains constant regardless of changes in frequency. This substantially reduces requirements on the amplifier and reduces costs over non-constant amplitude modulators for an otherwise equivalent signal.

Referring now to FIG. 5, FIG. 5 is a series of graphs illustrating the power spectral density for three FSK modulated waveforms each having a different modulation index.

In graph 510, an under-deviated FSK waveform is shown. That is to say that the separation between the two tones is too small or the symbol being transferred is too large. The modulation index of the FSK waveform of graph 510 is 0.32. This results in a poor use of the allowable power spectral density. The shaded portion of the graph represents the level of PSD for each frequency. As see in graph 510 for only one frequency, or a narrow frequency band in the center of the graph, is the allowable maximum PSD of −41.3 dBm/MHz attained. At all other frequencies, PSD is below allowable limits which will significantly degrade performance.

Graph 520 illustrates an FSK waveform having an ideal modulation index of 0.707.

As seen in graph 520, slope is improved over that of the FSK waveform of graph 510 and a significant portion of the bandwidth between the two tones is at the maximum allowable PSD. Graph 520 represents the ideal operating point for a CP-FSK modulated WB or UWB system according to this invention. The modulation index of approximately 0.707 provides a relatively efficient waveform, compared to those having a lower modulation index, and, as discussed above, also displays capture effect behavior.

Graph 530 illustrates an FSK waveform having a modulation index of 1. This is an extremely efficient waveform and would exhibit stronger capture properties than the waveform of graph 520. However, because of the limit on PSD, this waveform is undesirable. As seen in graph 530, the FSK waveform having a modulation of 1.0 displays discrete peaks at the symbol frequencies significantly reducing the allowable transmission power under current FCC rules. Because no single 1 Mhz band may transmit more than −41.3 dBm/MHz, only the frequencies which cause the peaks in the PSD will achieve the maximum power density, while the majority of the frequencies will transmit significantly under the maximum.

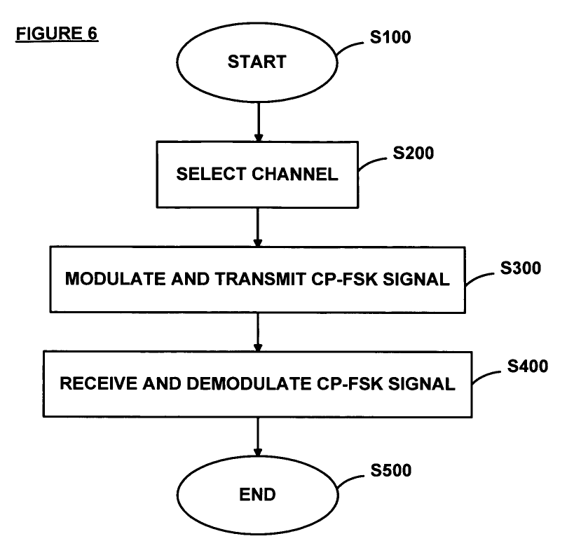

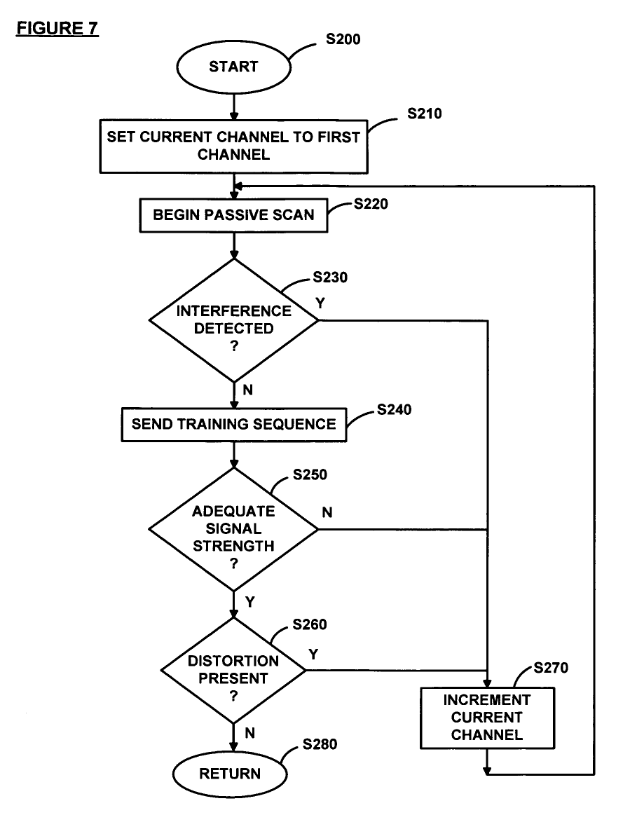

FIG. 6 is a flow chart illustrating the steps of a method of transmitting a CP-FSK modulated signal over a WB or a UWB channel in accordance with at least one embodiment of the invention. Operation of the method beings in step S100 and proceeds to step S200 were a suitable WB or UWB channel is selected. In various exemplary embodiments, the choice of channel will be dictated by local environment, presence of interference and other factors. A more complete discussion of this channel is provided in the following description of FIG. 7. Next, operation of the method proceeds to step S300 where the original data signal is FSK-modulated and wirelessly transmitted over the channel. Then, in step S400, the modulated wireless signal is remotely received and demodulated to recover the original data. Finally, operation of the method terminates in step S500.

FIG. 7 is a flow chart illustrating in greater detail the step of selecting a channel shown in FIG. 6, according to at least one embodiment of the invention. Operation of the method begins in step S200 and proceeds to step S210 where the receiver WB or UWB channel is set to a first WB or UWB channel from within the available spectrum. Then, operation of the method proceeds to step S220, where a passive scan of the first WB or UWB channel is begun. Next, at step S230, a determination is made whether interference has been detected on the channel. Interference may result from other WB or UWB devices, wireless communication devices operating in overlapping spectrum, or other background noise. In various exemplary embodiments, the presence of interference may be simply confirmed by monitoring the channel for the presence of RF energy. In various exemplary embodiments this may be accomplished be monitoring the particular channel for RF energy signals having a power level (amplitude) that is above a certain threshold. For example, any signals above a particular milliwatt power level may create sufficient interference to preclude successful data transmission. Therefore, if energy above this power level is detected that the current channel is presumed to be unusable. It should be appreciate that the particular threshold may change as demodulation techniques become more robust and also may change depending upon the particular type of data being transmitted. Various embodiments of the invention are not dependent upon the particular choice of threshold. Rather, it is contemplated that the threshold is a level above which the successful data communication is precluded or statistically unlikely.

If at step S230, a determination is made that interference is present on the current channel, operation of method jumps to step S270. Otherwise, an assumption is made that the current channel is sufficiently free of interference and operation of the method proceeds to step S240. In one exemplary embodiment of the invention, the current receiver may determine that no UWB channels are available for communications although WB channels may be available. In this case the receiver will configure itself for WB communications. The method in FIG. 7 is also applied to periodic scanning of the spectrum for optimization of channel frequency and bandwidth.

In step S240, a known training sequence is sent from the transmitter to the receiver to prove viability of the current channel. Then, in step S250, a determination is made at the receiver whether the known training sequence is of adequate signal strength. If, in step S250, a determination is made that the received training sequence is not of adequate signal strength, despite the previous determination that the current channel is free of interference, operation of the method jumps to step S270. Otherwise, operation of the method proceeds to step 260.

In step S260, a determination is made whether distortion is present on the current channel. Though a signal may be free of interference, and sufficiently strong, multi-path distortion due to the physical environment may prevent the signal from being successfully demodulated. Multi-path distortion causes the same signal to arrive at the receiver at different times. Thus, interfering signals may be range from sympathetic or destructive to the first signal. That is to say, that the signals may differ from zero to Π radians in phase from first signal. It is known that this multi-path distortion is highly dependent upon the center frequency of the signal as well as the bandwidth. Thus, for a given environment, different channels will exhibit varying degrees of multi-path interference. In various exemplary embodiments, the determination of the presence of multi-path distortion will be a determination of exclusion. That is to say, that if as determined in step S250, the signal strength of the training sequence is adequate for successful demodulation, but the signal cannot be successfully demodulated none the less, it will be assumed that the local environment is causing severe multi-path distortion for the current channel and an different channel must be found.

If, in step S260, it is determined that multi-path distortion is present, operation of the method proceeds to step S270, where the current channel is incremented to the next channel. Operation then returns to step S220 a passive scan of the current channel is performed. This process repeats until a channel that passes all tests is found. Returning to step S260, if it is determined that distortion is not present, that is the training sequence is able to be successfully demodulated, operation of the method advances to step S280 where operation returns to step S300 of FIG. 6 and the CP-FSK modulated signal is wirelessly broadcast over the current channel.

Thus, as described herein, a CP-FSK modulated signal will be sufficiently robust for WB or UWB communications over short distances. CP-FSK provides good PSD over the frequency band at much lower cost than that of the waveforms under current consideration for standardization. While DSSS and MB-OFDM are quite robust in attenuating multi-path interference, they suffer from increased complexity, cost and power consumption compared to various methods of WB or UWB communication in accordance with this invention. Moreover, selection of modulation index can be used to mitigate multi-path interference, particularly over the practical ranges. Furthermore, as outlined above, the particular channel can be chosen so as to avoid presently occupied channels and to reduce multi-path interference.

Various embodiments of the present invention will be particularly advantageous for cable replacement applications between computer devices such as personal computers, docking stations, modems, printers, scanners, etc., as well as consumer electronic devices such as satellite radio receivers, video cameras, digital still cameras, satellite and cable-based digital television receivers, VCRs, DVRs, etc. This will greatly simply interconnection of electronic components such as, for example, in an office containing various computer devices within close proximity to one another, or in a home theater type system incorporating many electronic devices interconnected to one another.

Other embodiments, uses, and advantages of the invention will be apparent to those skilled in the art from consideration of the specification and practice of the invention disclosed herein. The specification and drawings should be considered exemplary only, and not limiting as to the scope of the invention.

1. A method for transmitting data over a wireless network comprising:
scanning at least one of a plurality of wireless channels for RF energy above a threshold power level, said RF energy indicative of other interfering devices operating on the at least one channel;
selecting at least one channel that does not have interfering RF energy above the threshold level;
determining if at least one selected channel suffers from multi-path distortion; and
transmitting a CP-FSK modulated information signal on at least one channel that is determined not to suffer from multi-path distortion, where the transmitted signal has a power spectral density of ≦−41.3 dBm/MHz.

2. The method of claim 1, wherein the wireless channel is a UWB channel in the frequency range of 3.1 GHz to 10.6 GHz.

3. The method of claim 1, wherein the wireless channel is a WB channel in the frequency range of 5.925 GHz and 7.250 GHz.

4. The method of claim 1, wherein transmitting comprises transmitting a signal having a bandwidth of at least 500 MHz.

5. The method of claim 1, wherein transmitting comprises transmitting a signal having a bandwidth of at least 50 MHz.

6. The method of claim 1, wherein scanning at least one of a plurality of wireless channels comprises scanning the at least one channel for RF energy above a threshold power level, determining if the scanned channel suffers from multi-path distortion if there is no RF energy above the threshold level, and scanning a different channel if such RF energy is present.

7. The method of claim 1, further comprising increasing the signal bandwidth of the transmitted signal if the scanned channel and at least one adjacent channel are free of at least one of interfering RF energy and multi-path distortion.

8. The method of claim 1, transmitting further comprising transmitting a CP-FSK modulated information signal waveform with a modulation index of ≧0.707.

9. A wireless transmitter comprising:
a CP-FSK modulator;
an amplifier; and
a control circuit causing the transmitter and amplifier to select a channel and output a signal over the selected channel having a frequency spectrum between 3.1 and 10.6 GHz with a bandwidth of at least 500 MHz and a power spectral density of ≦−41.3 dBm/MHz.

10. The wireless transmitter of claim 9, wherein the frequency spectrum of the output signal is between 5.925 GHz and 7.250 GHz.

11. The wireless transmitter of claim 9, wherein the bandwidth of the output of signal is at least 50 MHz.

12. The wireless transmitter of claim 9, wherein the control circuit is adapted to cause the transmitter to scan for at least one of a plurality of wireless data channels having interfering RF energy below a threshold power level and determine if at least one of channel not having interfering RF energy suffers from multi-path distortion.

13. The wireless transmitter of claim 12, wherein the control circuit is further adapted to scan a different channel if at least of interfering RF energy and multi-path distortion are detected.

14. The wireless transmitter of claim 9, wherein the control circuit is adapted to increase a signal bandwidth of the output signal if the selected channel and at least one adjacent channel are sufficiently free of at least one of interference and multipath distortion.

15. The wireless transmitter of claim 9, wherein the modulator modulates a signal waveform with a modulation index of ≧0.707

16. A wireless communication system comprising:
a wireless transmitter; and
a wireless receiver, wherein the wireless transmitter is adapted to select a channel and to transmit a CP-FSK-modulated information signal having a bandwidth of at least 500 MHz and a power spectral density of ≦−41.3 dBm/MHz over the selected channel, and the wireless receiver is adapted to receive and demodulate and recover the information signal.

17. The system of claim 16, wherein the transmitter is further adapted to select at least one channel from a plurality of available channels that does not have any interfering RF energy above a threshold power level and that does not suffer from multi-path distortion.

18. The system of claim 17, wherein the transmitter is further adapted to increase a signal transmission bandwidth if the selected channel and at least one adjacent channel are sufficiently free of at least one of interfering RF energy and multi-path distortion

19. The system of claim 16, wherein the communication channel is a UWB channel in the frequency range of 3.1 GHz to 10.6 GHz.

20. The system of claim 16, wherein the communication channel is a WB channel in the frequency range of 5.925 GHz and 7.250 GHz and having a minimum bandwidth of 50 MHz.

21. The system of claim 16, wherein the CP-FSK modulated information signal has a modulation index of ≧0.707.
